(19) United States
(12) Patent Application Publication
(10) Pub. No.: US 2003/0101630 A1
(43) Pub. Date: Jun. 5, 2003

(54) Convertible identification badge holder

(76) Inventors: Ricardo M. Garcia, Orlando, FL (US); Ricardo J. Garcia, Caracas (VE)

Correspondence Address: VAN DYKE & ASSOCIATES, P.A., 7200 LAKE ELLENOR DRIVE, SUITE 252, ORLANDO, FL, 32809, US

(21) Appl. No.: 10/242,295

(22) Filed: Sep. 12, 2002

Related U.S. Application Data
(60) Provisional application No. 60/318,845, filed on Sep. 12, 2001.

(51) Int. Cl. G09F 3/18

(52) U.S. Cl. 40/658; 40/642.02

(57) ABSTRACT

A one-piece, injection-molded identification badge holder is disclosed. The product provides an economical alternative to typical badge holders by eliminating the need for component assembly or multiple molding steps during manufacturing. No labor involvement other than visual inspection and replenishment of stock material is required. The product has at least one detachable, interchangeable fastener that may be connected to a base plate to allow a user to display the holder in a vertical or horizontal position as desired. The holder may be worn around the neck or may be attached to any garment through alteration of the component parts.

### CROSS REFERNECE TO RELATED APPLICATION

This application claims the benefit under 35 USC §119(e) of Provisional Application No: 60/318,845, filed Sep. 12, 2001.

### TECHNICAL FIELD

This invention relates generally to identification badge holders, and more specifically to a one-piece injection-molded, convertible identification badge holder having a rotatable clip for horizontal or vertical wear.

### BACKGROUND

It has become standard practice in many industries to require employees or guests to wear identification badges to maintain a desired level of security. Also, attendees at social or business functions often utilize identification badges to facilitate introductions. Such usage has led to an increased demand for badge holders that may readily be attached to an article of clothing or otherwise carried on a person. Identification badge holders (hereinafter ID holder) are manufactured in a number of ways to accommodate different uses and budgets. The most common ID holder style is a single folded sheet of transparent plastic, comprising a rear portion, a face portion and a folded locking portion. This design is popular because it is economical in terms of the material involved. However, it does not allow a user to change the orientation of a badge from, for example, a horizontal to a vertical display. Other badge holders have a flat plastic member with a one or two prong clutch back pin mechanical fastener for securing the plastic member to a shirt, coat or other piece of clothing. These too restrict variability in orientation of the badge holder. Other ID holders use some independent third structure affixed to the badge to hold it in place. For example, U.S. Pat. No. 4,020,575 discloses a badge holder having a second sheet of plastic which needs to be ultrasonically welded to the backing portion of the badge holder itself. U.S. Pat. No. 2,213,449 uses a metal plate, spot welded to the badge holder. Other prior art have a pin element affixed directly to the reverse of the badge, or badge holder, without additional third structures. However, the methods used to manufacture each of the foregoing examples is labor intensive, requiring secondary assemblage of plastic and pin elements by workers. U.S. Pat. No. 3,466,773 discloses a molded plastic badge having parallel ridges, molded from the same material the badge is formed from, wherein the ridges are deformed under heat and pressure to connect pin elements to the plastic. However, that holder is comprised of two elements that must be manufactured separately. U.S. Pat. No. 3,054,201 issued to Burns discloses an identification badge having a detachable clip that may be changed at will such that the ID holder may be placed in a horizontal or vertical position. However, that ID holder is composed of two parts, which require distinct manufacturing processes. None of the aforementioned prior art disclose a one-piece ID holder which does not require assembly and/or two or more molding steps during manufacture, and which permits an end user to change the location of the fastener to change the orientation of the ID holder at will.

Injection molding has rapidly become the most widely used polymeric fabrication process. This process may be adapted to create a variety of items, including ID holders. However, one significant drawback to use of injection molding to create ID holders has been the relatively high initial equipment investment and running costs. A single mold may cost from between $5,000-$100,000 because each mold must be precisely designed to match the features of the object being created, and be strong enough to withstand high pressures associated with the manufacturing process, which may range from 5000 to 30,000 psi. Thus, typically the use of injection molding to produce relatively inexpensive ID holders is offset only when a very large number of products are produced. Another drawback to using injection molding to create inexpensive products is that many products having two or more parts require a separate mold for each part. A user may employ one mold at a time to create each part, but this significantly decreases the efficiency of manufacture, while increasing production costs. Alternatively, both molds can be used simultaneously if they are connected at some point to allow the melt to fill each mold chamber. However, when the two parts differ considerably in size, the smaller part may be damaged by the high pressure required to fill the larger chamber. One injection molded ID card holder w/a rotating clip for horizontal or vertical usage has been marketed by Compid, Inc. However, upon visual inspection of that ID holder it appears that it is manufactured in two parts, e.g. base plate and clip, which would require use of two separate molds. Whether the molds are used alone, or in combination, the overall cost of production is higher than if the entire ID holder were made from one mold. Also, because there are separate parts, some assembly would be required during manufacture, which also increases production costs. Assuming for a moment that a single mold was used to manufacture that product, several characteristics patentably distinguish it from the present invention. For example, that product provides a single clip design whereas the present invention provides alternate clip designs in the same product. Also, that product does not appear to have elevated ridges to protect a magnetic strip often present on the back of badges. Additionally, the present ID badge has a flat clip used for attaching a chain or like device for wear around a neck, whereas the Compid, Inc. badge has a narrow clip for attaching a chain or like device for wear around the neck, which extends behind the badge holder. The difference is important because this type of narrow, protruding clip design often causes a badge to turn away from the frontal plane and toward the body of the wearer, making visual inspection of the badge more difficult. The flat design of the present invention helps to keep the ID badge from turning, thereby facilitating easy inspection by an onlooker.

Thus, the ideal process of creating an ID card holder would reduce production costs through use of a single mold and elimination of labor intensive assemblage of parts. The present invention overcomes the above-discussed limitations and shortcomings of known ID badge holders.

### SUMMARY OF THE INVENTION

The present invention provides an identification card holder made of one-piece injection molded thermoplastic material. The one-piece ID holder contains two detachable parts. To show the ID holder in a horizontal or vertical position, an end user will detach one of the parts from the main ID Holder piece. Then that piece will be attached to the vertical or horizontal end of the ID Holder. Both pieces that detach may be mechanically locked to the main ID Holder by pressing both ends of the device and pushing small end tabs into the ID holder. One attachment has a clip-type shape to hold the badge to shirts or suit pockets. It can be used on either the horizontal or vertical attachment points of the badge holder. The other attachment device is an elongated ring-shape piece to be used with strap clips, a retractable reel holder, or neck string widely used by the identification industry. The present invention overcomes the deficiencies of the prior art by reducing labor costs through use of a single mold that produces a one-piece finished product that does not require assembly.

Accordingly an object of this invention is to provide a one-piece identification badge holder that can be attached to any surface and to which an identification badge can be attached.

Another object of the present invention is to provide a one-piece identification badge holder made by injection molding processes using a single mold, thereby requiring less labor while resulting in a durable, pleasing less costly product.

Another object of the present invention is to provide a one-piece identification badge holder having at least one attachment member, releasably affixed to the reverse of said holder, so as to allow quick and re-orientation of said holder at will.

Yet another object of the present invention is to provide a one-piece identification badge holder which is inexpensive to manufacture and adaptable to a range of identification badge sizes.

The foregoing objects, features and numerous advantages flowing from the present invention will be clarified from the following detailed description of an illustrative embodiment taken in connection with the accompanying drawings.

### BRIEF DESCRIPTION OF THE FIGURES

FIG. 1A shows a front view of one embodiment of the one-piece identification card holder of the present invention with fasteners attached.

FIG. 1B shows a front view of one embodiment of the one-piece identification card holder of the present invention with fasteners placed in horizontal and vertical positions.

FIG. 1C shows a side profile of one embodiment of the one-piece identification card holder of the present invention with the elongated ring holder in place.

FIG. 1D shows a side profile of one embodiment of the one-piece identification card holder of the present invention with the clip holder in place.

FIG. 2 shows a flow diagram depicting the process of manufacturing the present invention.

### DETAILED DISCLOSURE OF THE INVENTION

In a preferred embodiment, the present invention is a translucent or color rigid identification card holder. Preferably, the ID holder is manufactured according to the following process. A mold, preferably constructed of steel, is fitted to a molding machine. The mold is made to hold one or more a cavities that will act as the negative shape of the end product (ID Holder). The two halves of the mold are held closed and then attached to the molding machine. Preferably, the present invention is made from Acrylonitrile-Butadiene-Styrene, (ABS). However other materials may be used such as, for example, polycarbonate, HDPE, PS, PPS, PPO, PET, PBT, PU and other thermoplastic resins suitable for injection molding. In a preferred embodiment, colorless thermoplastic ABS pellets are mixed with a color pigment powder to produce a desired color for the final product. The colored ABS pellets are then transported to an injection molding machine plastic feeder canister. The ABS pellets are then subjected to high temperature, generally between 400° F. and 750° F., sufficient to cause a phase change from solid to liquid. The molten material is then injected into the mold via a hole (sprue) in the mold under pressure (usually between 5000 and 30000 psi). After the mold chamber(s) is filled, the mold is then chilled until the plastic hardens. The mold halves are then separated and the single component product is ejected from the mold through mechanical injection points. The final product is then passed through a quality control inspection. Those ID holders that pass inspection are packaged and stored, while those having imperfections are shredded and recycled for future use. This cycle is then repeated. No additional processing is required to convert the virgin material into finished goods. Further, no labor involvement other than visual inspection and replenishment of plastic pellets into the injection molding feeder canister is required.

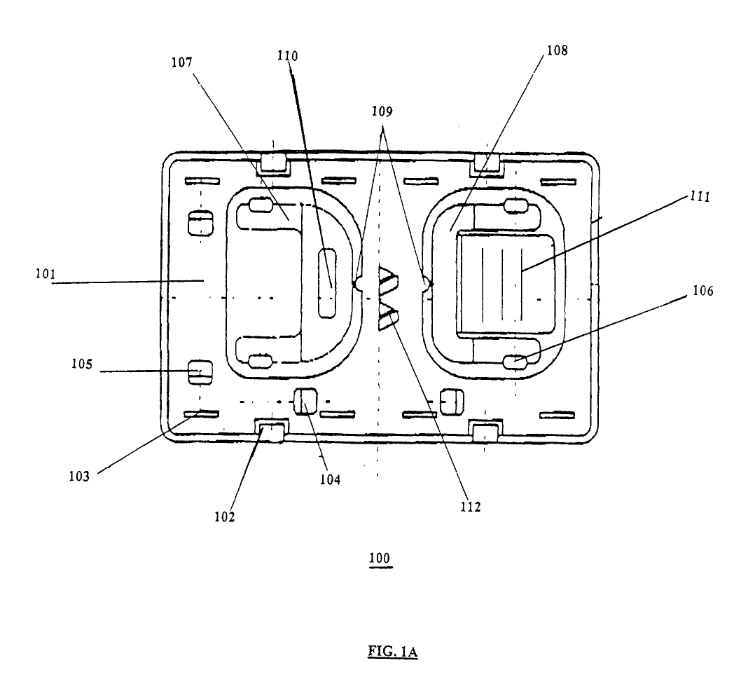

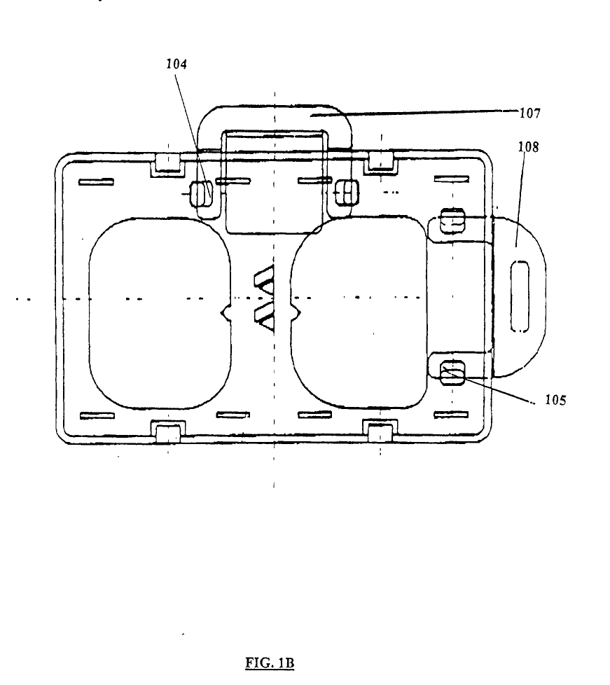

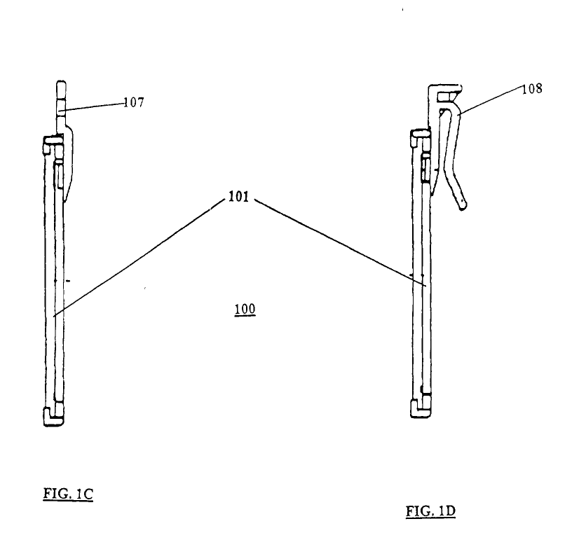

FIG. 1A shows a front view of one embodiment of the present invention. The one-piece Identification Badge Holder hereinafter “ID holder” is generally indicated at 100. The ID holder comprises a base plate 101 for holding a card, badge, ID, or like document. Perpendicular supports 102 hold a displayed document in place. A series of elevated ridges 103 positioned on the base plate 101 serve to lift up the document such that it does not remain in contact with the base plate 101. This feature allows a user to protect and display an ID without damaging the magnetic strip often located on the back of a badge. Horizontal perforations 104 and vertical perforations 105 are designed to receive the ends 106 of two detachable parts, an elongated ring-shape fastener 107 and clip-type fastener 108. The ring-type fastener 107 is used for strap clips, retractable real holder or neck strings widely used in the identification industry. The clip-type fastener 108 is used to hold the badge to garments. The elongated ring-type fastener 107 and clip-type fastener 108 are initially attached to the base plate via a small plastic remnant 109. The end user, to show his/her ID badge information in a vertical or horizontal disposition, will detach one of the fasteners from the base plate. Both fasteners can be detached by twisting the fastener in a direction away from the base plate until the plastic remnant 109 snaps. A preferred fastener may then be mechanically locked into the base plate 101 for use by pressing both ends 106 of the fastener and pushing the ends into either horizontal 104 or vertical 105 perforations. The ends of both fasteners have the same dimensions to enable use of a preferred fastener in either the horizontal or vertical position. In those situations where last minute additions and changes to a badge or other identification card is common, such as, for example, during a convention, the ability to switch the badge holder from a horizontal to a vertical orientation at will, is highly desirable. The elongated ring-type fastener 107 has an aperture 110 to allow receipt of a chain, lanyard, string or similar device for hanging the ID holder from a portion of the body. The fastening device is compatible with any type of ID holding device currently used. The clip-type fastener 108 has a series of ridges 111, which function to securely hold the ID holder in place when attached to an article of clothing. A company name, logo or other identifying mark 112 may be placed on the base plate 101.

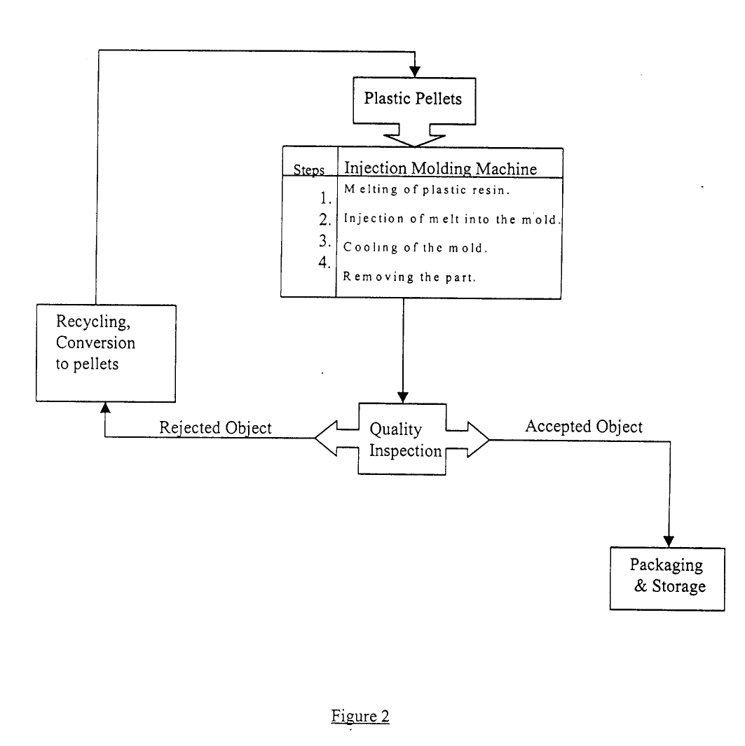

FIG. 1B shows a front view of the ID holder with both elongated ring-type fastener 107 and clip-type fastener 108 removed. As shown, the clip-type fastener 108 is affixed to the base plate 101 via the horizontal perforations 104, and the elongated ring-type fastener 107 is affixed to the base plate 101 via vertical perforations 105. The fasteners are designed to be interchangeable to allow for different configurations and sites of attachment. FIG. 1C shows a side profile of the ID holder 100 with elongated ring-type fastener 107 attached to base plate 101. FIG. 1D shows a side profile of the ID holder 100 with clip-type fastener 108 attached to the base plate. FIG. 2 shows a flow diagram of the manufacturing process used to create the present invention. Those skilled in the art will recognize that slight modifications to the dimensions of the ID holder will permit construction of a wide variety of products such as stationary holders, office disclaimer holders, advertisement holders, etc.

The current invention takes advantage of the high production rate associated with injection molding processes to manufacture the product in large quantities, while simultaneously reducing costs by eliminating labor intensive assembly. By using one mold, start-up cost is reduced and product quality is more consistent resulting in greater production volume per unit of time. It is to be understood that the mold is a negative shape of the identification badge holder. The mold is designed to produce a badge holder that produces easily detachable fasteners, which lock into perforations to display the badge or display document in a vertical or horizontal orientation.

The teachings of all patents cited throughout this specification are incorporated by reference in their entirety to the extent not inconsistent with the teachings herein. It should be understood that the embodiments described herein are for illustrative purposes only and that various modifications or changes in light thereof will be suggested to persons skilled in the art and are to be included within the spirit and purview of this application and the scope of the appended claims.

What is claimed is:

1. A one-piece identification badge holder comprising a badge holder base plate member, at least one detachable, interchangeable fastener, and at least one retainer member for holding an identification badge in place.

2. The identification badge holder of claim 1, wherein said badge holder does not require assembly during manufacture.

3. The identification badge holder of claim 1, wherein said badge holder is produced by injection molding

4. The identification badge holder of claim 1, wherein said badge holder is made from a single mold.

5. The identification badge holder of claim 1, wherein said at least one detachable, interchangeable fastener can be connected to said holder to display said holder in a horizontal or vertical position.

6. The identification badge holder of claim 5, wherein said fastener is a clip-type fastener.

7. The identification badge holder of claim 6, wherein said fastener has ridges placed thereon to secure said fastener to said garment.

8. The identification badge holder of claim 5, wherein said fastener is a elongated ring-type fastener.

9. The identification badge holder of claim 8, wherein said elongated ring-type fastener has an aperture whereon a strap clip, a retractable reel holder, a neck string or the like is affixed.

10. The identification badge holder of claim 1, wherein said holder is made from thermoplastic material.

11. The identification badge holder of claim 10, wherein said thermoplastic material is selected from the group comprising ABS, polycarbonate, HDPE, PS, PPS, PPO, PET, PBT, PU or combinations thereof.

12. A method of manufacturing a one-piece identification badge holder comprising the steps of:
a). melting a thermoplastic material;
b) filling a mold chamber with said melted material; and
c) allowing said melted material to solidify

13. The method of claim 12, further comprising constructing a single mold, such that all required components of said badge holder are created in a single product upon filling of said mold.

14. The method of claim 12, wherein said one-piece identification badge holder comprises at least a badge holder base plate member, at least one detachable, interchangeable fastener, and at least one retainer member for holding a identification badge in place.

15. The method of claim 12, further comprising mixing thermoplastic material with a desired color pigment powder to produce colored material.

16. The method of claim of claim 15, wherein said thermoplastic material is selected from the group comprising ABS, polycarbonate, HDPE, PS, PPS, PPO, PET, PBT, PU or combinations thereof.

17. The method of claim 12, further comprising transporting said colored material to an injection molding machine plastic feeder canister, heating said colored material to a temperature which causes a phase change in said material from solid to molten liquid, and injecting said molten material under pressure into said mold.

18. The method of claim 12, wherein a one-piece identification badge holder does not require assembly during manufacture.

19. The method of claim 12, wherein said method may be modified to produce products adapted for larger or smaller displays of information.

20. A document display holder comprising a holder base plate and at least one detachable, interchangeable fastener, wherein said document display holder is manufactured by injection molding using a single mold.

21. The document display holder of claim 20, wherein said document display holder is configured such that said at least one fastener locks into said base plate to display a document positioned in said document display holder in a vertical or horizontal orientation.
